(19) United States
(12) Patent Application Publication
(10) Pub. No.: US 2006/0266579 A1
(43) Pub. Date: Nov. 30, 2006

(54) Inflatable megaphone

(76) Inventors: Deane Stern, Bangor, ME (US); Hal Meyers, Eddington, ME (US)

Correspondence Address: ANTHONY D. PELLEGRINI RUDMAN & WINCHELL, LLC, 84 HARLOW STREET, P.O. BOX 1401, BANGOR, ME, 04402-1401, US

(21) Appl. No.: 11/439,848

(22) Filed: May 24, 2006

Related U.S. Application Data
(60) Provisional application No. 60/684,449, filed on May 25, 2005.

(51) Int. Cl. G10K 11/00

(52) U.S. Cl. 181/178

(57) ABSTRACT

The present invention is an inflatable acoustic megaphone that can be inflated into a substantially frustoconical shape for use and deflated and folded into a relatively small space when not in use, optionally providing text and/or graphics on its surface that can be used for advertising or promotions.

### CROSS REFERENCE TO RELATED APPLICATION

This application claims priority to a provisional application, U.S. Ser. No. 60/684,449, filed May 25, 2005, entitled Inflatable Megaphone, by Meyers, Hal and Stern, Deane, which is hereby incorporated by reference.

### BACKGROUND OF THE INVENTION

1. Technical Field

The invention relates generally to the field of novelty toys and devices. More specifically, the invention is directed to an improved inflatable acoustic megaphone which may be inflated for use and deflated when not in use, thereby improving portability, accessibility, and convenience of use of the device.

2. Description of Prior Art

Megaphones are well-known in the art. A megaphone is typically a cone-shaped device designed to amplify or transmit sound. Megaphones are often used at sporting events, protests, rallies, and for crowd control. Their benefits are that they do not require a sound system, or a microphone, and the device is hand-held and portable. Most megaphones used today are electronic, with a small battery powered amplifier. This type of megaphone is also referred to as a bullhorn.

Traditional acoustic megaphones, however, have the disadvantage of being relatively large and bulky (in order provide a suitable sound enhancing chamber), and therefore are inconvenient to carry, store, ship, etc. They are typically constructed of heavy-gauge paper or cardboard, or substantially rigid material such as plastic. As such, these devices cannot be collapsed and folded into relatively small spaces without ruining their ability to subsequently perform as intended.

None of the known art discloses a simple, inexpensive, inflatable, flexible, collapsible, and foldable device that can be used as a megaphone, as a container, as an article of headgear, and as an advertising or promotional vehicle.

### SUMMARY OF THE INVENTION

The present invention discloses an inflatable megaphone that can inflated for use or deflated for storage. It has a substantially frustoconical shape with an opening at each end and a hollow interior. It is formed of two panels bonded together to define an interior air bladder, and comprises a means for filling the air bladder with air and then sealing the air bladder to prevent the escape of air. The device is constructed of a durable, flexible material, allowing it to be deflated and folded. In the preferred embodiment the exterior of the megaphone may comprise text, graphics, or a combination of both. This embodiment is particularly suited for use of the device at sporting events.

In the most preferred embodiment the present invention comprises a plurality of reinforcing ribs suitably adapted to substantially prevent the interior panel from expanding more than minimally into the hollow interior of the megaphone when the megaphone is inflated. This ensures the megaphone retains its basic frustoconical shape during use.

The present invention, when inflated, may be used as a megaphone. It may also be used as a novelty container by orienting the device substantially vertically and occluding the smaller opening. Another potential use of the inflated device is as a novelty hat.

It is an objective of the present invention to provide a useful, inexpensive acoustic megaphone that can be inflated into a substantially frustoconical shape for use and deflated and folded into a relatively small space when not in use.

It is a further objective of the present invention to provide an inflatable acoustic megaphone that can be used as a container.

It is a further objective of the present invention to provide an inflatable acoustic megaphone that can be used as an article of headgear.

It is a further objective of the present invention to provide an inflatable acoustic megaphone that can be used as an advertising or promotional vehicle.

It is a further objective of the present invention to provide an inflatable acoustic megaphone that is easy and economical to manufacture.

Other objectives of the present invention will be readily apparent from the description that follows.

### DETAILED DESCRIPTION OF THE DRAWINGS

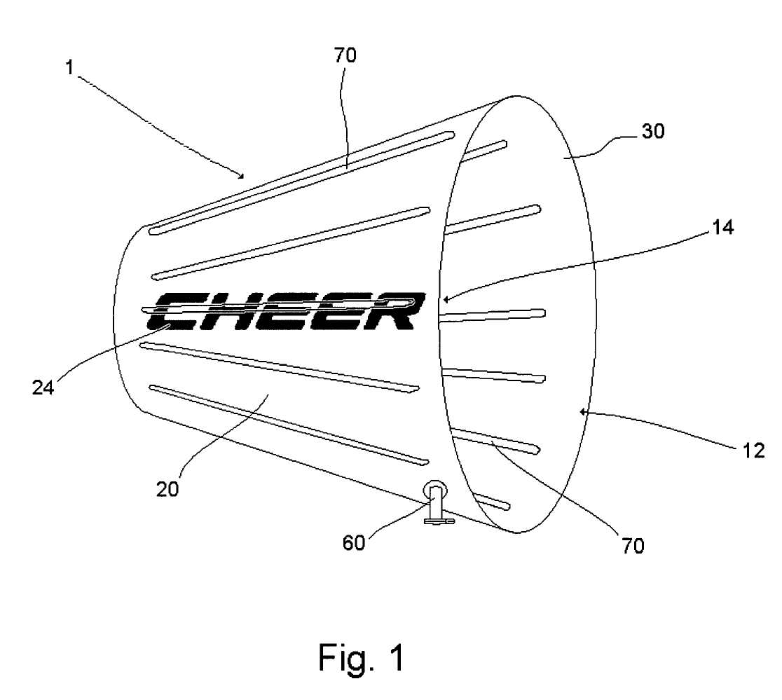

FIG. 1 is perspective view of the present invention.

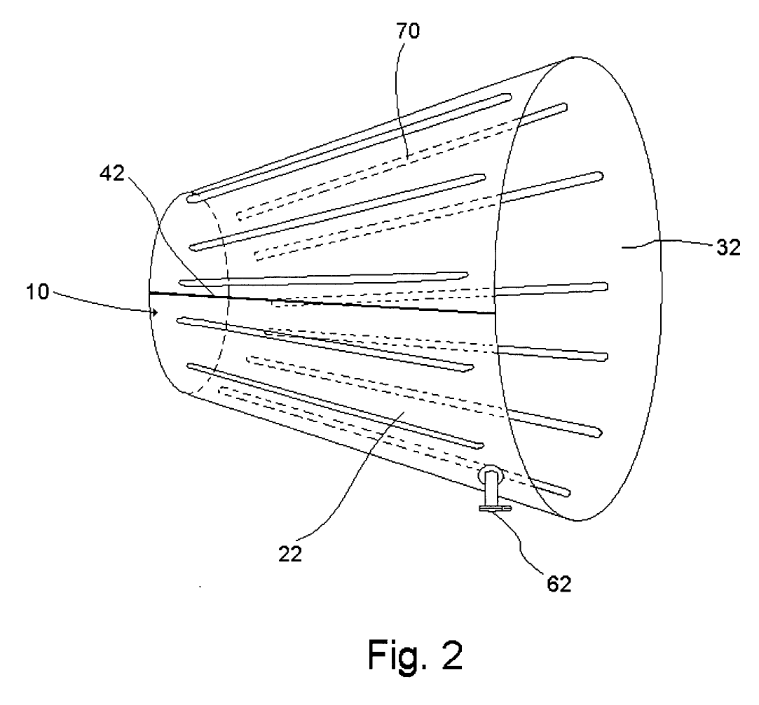

FIG. 2 is perspective view of the present invention depicting the reinforcing ribs in greater detail.

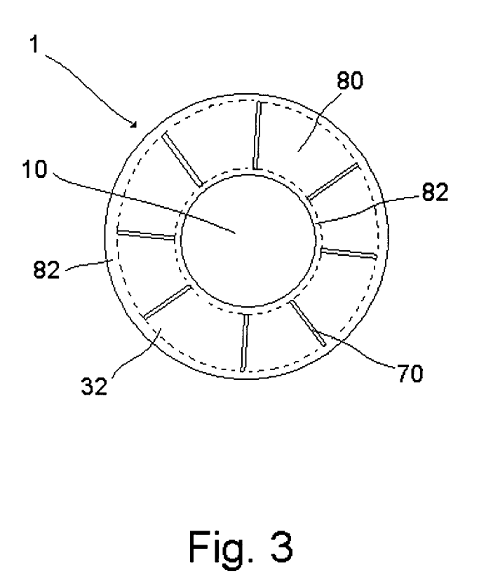

FIG. 3 is a front view of the present invention depicting the interstitial chambers and circumferential chambers, delineated by dotted lines.

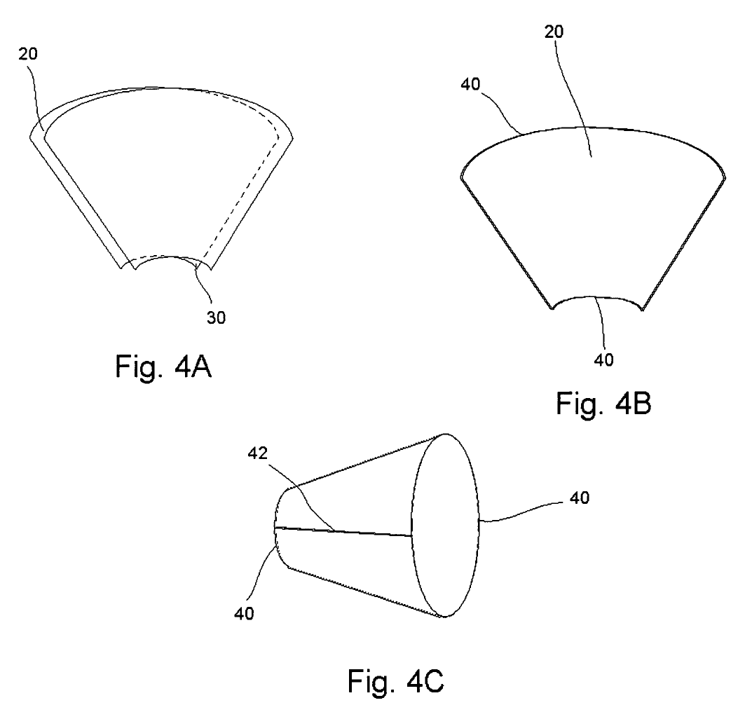

FIG. 4A is a top view of a step in a method of manufacture of the present invention, depicting the exterior panel being placed over the interior panel.

FIG. 4B is a top view of a subsequent step in a method of manufacture of the present invention, depicting the exterior panel being partially bonded to the interior panel by circumferential seams.

FIG. 4C is a perspective view of a subsequent step in a method of manufacture of the present invention, depicting the exterior and interior panels rolled into a frustoconical shape and being sealed by the longitudinal seam.

### DETAILED DESCRIPTION OF THE INVENTION

The present invention relates to an inflatable megaphone 1. When inflated, the device 1 may be placed against a user's mouth to amplify sounds made by the user. When deflated, the device 1 may be folded into a relatively small space for easy of storing or transport.

As shown in FIG. 1, the device 1, when inflated, has a substantially frustoconical shape, with an opening 10, 12 at each end and a hollow interior 14. The first opening 10, into which the user will speak, is substantially smaller than the second opening 12, from which sound emits. The device 1 comprises an exterior panel 20 and an interior panel 30, and has an exterior surface 22 formed by the exterior panel 20 and an interior surface 32 formed by the interior panel 30. The interior surface 32 of the device 1 need not be perfectly smooth, but may have local variations in contour and texture, provided that on the whole the interior surface 32 of the device 1 has a substantially frustoconical shape to allow amplification of sound waves. The device 1 is constructed of a durable, flexible material, preferably rubberized plastic.

The exterior panel 20 is bonded to the interior panel 30 along two circumferential seams 40, each seam 40 situated along a perimeter of one of the two openings 10,12, respectively, thereby forming an air-tight enclosed space between the two panels 20,30 which serves as an interior air bladder. See FIG. 4B. A sealable aperture 60 is formed into the device 1 to access the interior bladder. Air is placed into the device 1 for inflation purposes through the scalable aperture 60, and air is expelled from the device 1 for deflation purposes through the sealable aperture 60. In the preferred embodiment the sealable aperture 60 is sealed and unsealed by use of a valve 62 placed therein. When the valve 62 is sealed air cannot pass through the sealable aperture 60. The sealable aperture 60 represents the sole means for moving air into or out of the interior bladder of the device 1. In an alternative embodiment the device 1 may have a plurality of sealable apertures 60. In yet another embodiment the device 1 may have a plurality of valves 62, one valve 62 placed within each of the plurality of sealable apertures 60.

In the preferred embodiment the device 1 comprises a plurality of reinforcing ribs 70. See FIG. 2. The ribs 70 are suitably adapted to substantially prevent the interior panel 30 from expanding more than minimally into the hollow interior 14 of the device 1 when the device 1 is inflated, thereby ensuring the interior 14 of the device 1 retains its basic frustoconical shape during use. The ribs 70 may be located along or within one or both panels 20,30 of the device 1 or between the panels 20,30 or any combination thereof. The ribs 70 may be linear or curved, and oriented longitudinally, transversely, circumferentially, or at random, provided they achieve the purpose described above. In one embodiment there is only a single rib 70, oriented in a circumferential spiral around the device 1.

In the most preferred embodiment, the ribs 70 are substantially linear and are oriented substantially longitudinally along the side of the device 1 and located between the first opening 10 and the second opening 12. In this embodiment each rib 70 is formed by bonding a portion of the exterior panel 20 to a corresponding portion of the interior panel 30. This may be done by the application of heat, as is well known in the art, or by application of an adhesive, or by any other suitable means. In this embodiment the ribs 70 do not extend all the way along the side of the device 1 but rather each rib 70 terminates a suitable distance from either opening, said distance being sufficient to allow the exterior panel 20 and the interior panel 30 to separate between each end of the rib 70 and the corresponding opening. The ribs 70 are preferably disposed around the circumference of the device 1 in a substantially uniform manner. So constructed, the device 1 comprises multiple interstitial chambers 80, each interstitial chamber 80 located between a pair of ribs 70, with each interstitial chamber 80 open at either end to two circumferential chambers 82, each circumferential chamber 82 proximate to one of the openings 10,12 of the device 1. See FIG. 3. Air placed into the device 1 through the sealable aperture 60 flows freely through each interstitial chamber 80 and the two circumferential chambers 82. Other embodiments of the reinforcing ribs 70 are contemplated, provided that any chamber 80,82 formed by one or more of the ribs 70 is in direct or indirect communication with at least one sealable aperture 60 so that air may fill said chamber 80,82.

In another embodiment the exterior panel 20 and interior panel 30 are further bonded together along a longitudinal seam 42 extending from the first opening 10 to the second opening 12. See FIG. 4C. This embodiment results from an efficient method of manufacture of the device 1. This method of manufacture comprises placing the two panels 20,30 of the device 1 adjacent to each other, see FIG. 4A, and then sealing the perimeter, forming a dual layered component. See FIG. 4B. Two of the sides of the dual layered component are then brought together and bonded to each other, thereby forming the frustoconical shape of the device 1. See FIG. 4C.

In yet another embodiment the exterior panel 20 and interior panel 30 are formed of a single shaped sheet of material. The sheet is folded onto itself, with the fold forming the perimeter of the first opening 10. The remaining edges of the exterior and interior panels 20,30 are bonded as described above, forming a dual layered component, with assembly completed as described above. This embodiment has the advantage of presenting a smooth, seamless edge along the perimeter of the first opening 10, thereby preventing injury to a user's mouth from sharp edges. Other methods of manufacture are also contemplated.

In one embodiment of the device 1 the exterior surface 22 may comprise text 24, graphics 24, or a combination of both. See FIG. 1. This embodiment is particularly suited for use of the device 1 at sporting events, where team names and logos may be placed upon or affixed to the exterior surface 22 of the device 1.

The device 1, when inflated, may be used as a megaphone. It may also be used as a novelty container by orienting the device 1 substantially vertically, with the larger opening oriented above the smaller opening, and thereafter placing into the interior 14 of the device 1 a substantially spherical object with a diameter larger than the diameter of the smaller opening. The spherical object may be a ball, preferably an inflatable ball. So disposed, the spherical object substantially seals the smaller opening, and items may be placed into the device 1 through the larger second opening 12 and are prevented from falling through the smaller first opening 10 by the spherical object. Examples of items that may be contained by the device 1 include foodstuffs, such as popcorn, chips, or pretzels; small novelty toys, such as giveaways at sporting events; and the like. When the container function of the device 1 is no longer needed or desired, the spherical object may be removed and the device 1 used as a megaphone, or deflated. The exterior surface of the spherical object may also comprise text 24, graphics 24, or a combination of both. The user can expel the spherical object from the device 1 by forcing air into the first opening 10, thereby creating, when performed simultaneously or nearly simultaneously with others, a festive effect. Another potential use of the inflated device 1 is as a novelty hat. The larger opening of the device 1 is fitted over the head and the device 1 is oriented substantially vertically.

The device 1 is deflated by opening the sealable aperture 60 and applying pressure to the exterior and/or interior panels 20,30 until substantially all of the air within the interior bladder of the device 1 is expelled. The device 1 may then be folded into a relatively small space, allowing for convenient storage or portability, for example in a user's pocket.

I claim:

1. An inflatable megaphone comprising
an exterior panel;
an interior panel;
an interior bladder; and
a sealable aperture;
with the inflatable megaphone constructed of a flexible material and when deployed for use having a substantially frustoconical shape, an exterior surface, an interior surface, a hollow interior, a first opening at one end of the hollow interior, and a second opening at an opposite end of the hollow interior, said second opening being larger than the first opening,
wherein the exterior panel is attached to the interior panel,
the interior bladder is formed between the exterior panel and the interior panel, said interior bladder being suitably adapted to contain a quantity of air, and the sealable aperture is suitably adapted to permit access to the interior bladder, said sealable aperture having an opened state and a closed state, whereby when in the opened state the sealable aperture permits air to be inserted into or expelled from the interior bladder, and when in the closed state the scalable aperture prevents air from being inserted into or expelled from the interior bladder;
whereby the inflatable megaphone is prepared for use by inserting air into the interior bladder through the scalable aperture in its opened state, thereby inflating the megaphone, then placing the sealable aperture in its closed state to retain the air within the interior bladder, and the inflatable megaphone is prepared for storage by expelling air from the interior bladder through the sealable aperture in its opened state, thereby deflating the megaphone, then optionally folding the megaphone.

2. The inflatable megaphone of claim 1 wherein the inflatable megaphone is constructed of a rubberized plastic.

3. The inflatable megaphone of claim 1 wherein one or more of the following group is placed upon the exterior surface: text and graphics.

4. The inflatable megaphone of claim 1 wherein the sealable aperture is located on the exterior surface.

5. The inflatable megaphone of claim 1 wherein the sealable aperture is located on the interior surface.

6. The inflatable megaphone of claim 1 wherein the sealable aperture comprises a valve suitably adapted to seal and unseal the sealable aperture.

7. The inflatable megaphone of claim 1 comprising a plurality of scalable apertures with each said sealable aperture suitably adapted to permit access to the interior bladder, said sealable aperture having an opened state and a closed state, whereby when in the opened state the sealable aperture permits air to be inserted into or expelled from the interior bladder, and when in the closed state the sealable aperture prevents air from being inserted into or expelled from the interior bladder.

8. The inflatable megaphone of claim 7 wherein each of the sealable apertures comprises a valve suitably adapted to seal and unseal said sealable aperture.

9. The inflatable megaphone of claim 1 further comprising one or more reinforcing ribs,
with each said rib suitably adapted to substantially prevent the inner panel from expanding more than minimally into the hollow interior.

10. The inflatable megaphone of claim 9 wherein at least one of the one or more reinforcing ribs is located along the exterior panel.

11. The inflatable megaphone of claim 9 wherein at least one of the one or more reinforcing ribs is located along the interior panel.

12. The inflatable megaphone of claim 9 wherein at least one of the one or more reinforcing ribs is located between the exterior panel and the exterior panel.

13. The inflatable megaphone of claim 9 wherein at least one of the one or more reinforcing ribs is substantially linear.

14. The inflatable megaphone of claim 9 wherein at least one of the one or more reinforcing ribs is substantially curved.

15. The inflatable megaphone of claim 1 further comprising one reinforcing rib,
with said rib suitably adapted to substantially prevent the inner panel from expanding more than minimally into the hollow interior, and
said rib oriented in a circumferential spiral around the inflatable megaphone.

16. The inflatable megaphone of claim 1 further comprising a plurality of reinforcing ribs,
with each said rib being suitably adapted to substantially prevent the inner panel from expanding more than minimally into the hollow interior,
each said rib being substantially linear,
each said rib being oriented substantially longitudinally along the megaphone and substantially perpendicular to a place of the first opening, and
each said rib being located between the first opening and the second opening, terminating a suitable distance from either opening, said distance being sufficient to allow the outer panel and the inner panel to separate between said rib and the proximate opening;
wherein the plurality of ribs define a plurality of interstitial chambers located between the exterior panel and the interior panel and a pair of circumferential chambers located between the exterior panel and the interior panel, each interstitial chamber located between a pair of ribs, with each interstitial chamber open at either end to the two circumferential chambers, one of the circumferential chambers located between the plurality of ribs and the first opening and the other of the circumferential chambers located between the plurality of ribs and the second opening,
whereby air placed into the megaphone through the scalable aperture is able to flow freely into and through each interstitial chamber and each circumferential chamber.

17. The inflatable megaphone of claim 1 further comprising a stopper,
said stopper being substantially spherical and having a diameter larger than the first opening;
whereby the stopper is suitably adapted to be placed into the hollow interior and frictionally secured against the interior surface proximate to the first opening, thereby effectively occluding the first opening.

18. The inflatable megaphone of claim 18 wherein the stopper is inflatable.
